(19) United States
(12) Patent Application Publication
(10) Pub. No.: US 2025/0206380 A1
(43) Pub. Date: Jun. 26, 2025

(54) VEHICLE LOWER PART STRUCTURE

(71) Applicant: TOYOTA JIDOSHA KABUSHIKI KAISHA, Aichi-ken (JP)

(72) Inventor: Keisuke TOYOTA, Nagakute-shi (JP)

(21) Appl. No.: 18/985,023

(22) Filed: Dec. 18, 2024

(30) Foreign Application Priority Data
Dec. 22, 2023 (JP) 2023-217309

(51) Int. Cl. B62D 21/15; B62D 25/20

(52) U.S. Cl. CPC B62D 21/157; B62D 25/2036

(57) ABSTRACT

A vehicle lower part structure includes a side frame having a closed cross-section structure, the side frame extending in a vehicle front and rear direction on an outer side of a battery in a vehicle width direction, the side frame being provided at a location where the side frame overlaps at least part of the battery in a vehicle side view, and a side member having a closed cross-section structure, the side member being disposed on an outer side of the side frame in the vehicle width direction, the side member being provided at a location where the side member overlaps at least part of the side frame in a vehicle side view, the side member being fastened to the side frame by a fastening member.

### CROSS-REFERENCE TO RELATED APPLICATION

This application claims priority to Japanese Patent Application No. 2023-217309 filed on Dec. 22, 2023, incorporated herein by reference in its entirety.

### BACKGROUND

### 1. Technical Field

The disclosure relates to a vehicle lower part structure.

### 2. Description of Related Art

Chinese Patent Application Publication No. 115140194 describes a structure in which a floor reinforcement extending in a vehicle front and rear direction is provided on an inner side of a rocker in a vehicle width direction. The rocker is a framework of a vehicle. In the structure described in Chinese Patent Application Publication No. 115140194, a battery is mounted on an inner side of the floor reinforcement in the vehicle width direction, and the battery is fastened to the floor reinforcement.

### SUMMARY

In the structure described in Chinese Patent Application Publication No. 115140194, the floor reinforcement is disposed so as to be spaced apart from the rocker, so the size between the right and left floor reinforcements reduces, and space for mounting the battery cannot be increased. On the other hand, if a battery case is extended up to the rockers, space for mounting the battery can be ensured; however, the size between the right and left rockers varies among vehicle types, so the size of the battery case needs to be changed for every vehicle type.

The disclosure provides a vehicle lower part structure that ensures space for mounting a battery with high versatility of a battery case.

A vehicle lower part structure according to an aspect of the disclosure includes: a side frame having a closed cross-section structure, the side frame extending in a vehicle front and rear direction on an outer side of a battery in a vehicle width direction, the side frame being provided at a location where the side frame overlaps at least part of the battery in a vehicle side view; and a side member having a closed cross-section structure, the side member being disposed on an outer side of the side frame in the vehicle width direction, the side member being provided at a location where the side member overlaps at least part of the side frame in a vehicle side view, the side member being fastened to the side frame by a fastening member.

In the vehicle lower part structure, the side frame extends in the vehicle front and rear direction on the outer side of the battery in the vehicle width direction. The side frame has a closed cross-section structure and is provided at a location where the side frame overlaps at least part of the battery in a vehicle side view. Thus, a collision load input from a side of the vehicle in the event of a side collision of the vehicle (hereinafter, referred to as “in the event of a side collision” as needed) can be received by the side frame, so the battery is protected.

The side member is disposed on the outer side of the side frame in the vehicle width direction, and the side member is fastened to the side frame by the fastening member. In this way, with the structure that the side frame and the side member are fastened by the fastening member, the side frame is proximate to the side member, and space for mounting the battery in the vehicle width direction can be ensured.

Furthermore, the side member has a closed cross-section structure and is provided at a location where the side member overlaps at least part of the side frame in a vehicle side view. In this way, the side frame and the side member each having a closed cross-section structure and fastened by the fastening member can function as a rocker that is a vehicle framework member. Then, the vehicle lower part structure is applicable to vehicles having different vehicle ranks just by changing the side member, so the battery and the side frame do not need to be changed, and the structure has high versatility.

In the vehicle lower part structure according to the above aspect, an outer energy absorbing member may be provided in a cross section of the side member.

With the vehicle lower part structure, when the outer energy absorbing member is provided in the cross section of the side member, at least part of a collision load input from the side of the vehicle in the event of a side collision can be absorbed by the outer energy absorbing member.

In the vehicle lower part structure according to the above aspect, an inner energy absorbing member may be provided in a cross section of the side frame at a location where at least part of the inner energy absorbing member overlaps the outer energy absorbing member in a vehicle side view.

With the vehicle lower part structure, when the inner energy absorbing member is provided in the cross section of the side frame, at least part of a collision load input from the side of the vehicle in the event of a side collision can be absorbed by the inner energy absorbing member. At least part of the inner energy absorbing member overlaps the outer energy absorbing member in a vehicle side view. For this reason, a load can be effectively absorbed by both the outer energy absorbing member and the inner energy absorbing member, and a load input to the battery can be reduced.

In the vehicle lower part structure according to the above configuration, a floor cross member extending in the vehicle width direction may be connected to the side frame, and the inner energy absorbing member may be provided at a location where at least part of the inner energy absorbing member overlaps the floor cross member in a vehicle side view.

With the vehicle lower part structure, the floor cross member extending in the vehicle width direction is connected to the side frame. The inner energy absorbing member is provided at a location where at least part of the inner energy absorbing member overlaps the floor cross member in a vehicle side view. For this reason, a collision load input from the side of the vehicle in the event of a side collision can be absorbed by the inner energy absorbing member and can also be transmitted to an anti-collision side via the side frame and the floor cross member. As a result, a load input to the battery can be effectively reduced.

In the vehicle lower part structure according to the above aspect, a front pillar extending in a vehicle up and down direction may be connected to a vehicle front side of the side member, and a center pillar extending in the vehicle up and down direction may be connected to the side member on a vehicle rear side of the front pillar.

With the vehicle lower part structure, when the front pillar and the center pillar are connected to the side member, a side module including the side member, the front pillar, and the center pillar is formed. Thus, when the side member, the front pillar, and the center pillar are modularized in advance, the framework of the vehicle can be formed just by fastening the battery and the side frame to the modularized side module.

In the vehicle lower part structure according to the above aspect, a wall of the side frame at an outer side in the vehicle width direction and a wall of the side member at an inner side in the vehicle width direction may be fastened by the fastening member in the vehicle width direction.

With the vehicle lower part structure, the side frame and the side member are fastened by the fastening member in the vehicle width direction. Thus, in the event of a side collision, a load is input along an axial direction of the fastening member, so a good fastened state can be maintained as compared to a case where a load is input to the fastening member in a shearing direction in the event of a side collision like a structure fastened one above the other by a fastening member.

In the vehicle lower part structure according to the above configuration, the outer energy absorbing member may be disposed at an upper part in the cross section of the side member, the inner energy absorbing member may be disposed at an upper part in the cross section of the side frame, and the fastening member may be disposed below the outer energy absorbing member and the inner energy absorbing member.

With the vehicle lower part structure, by separating a region in which the outer energy absorbing member and the inner energy absorbing member are disposed and a region in which the fastening member is disposed, one above the other, it is possible to reduce interference of the outer energy absorbing member and the inner energy absorbing member at the time of fastening the side frame and the side member to each other by the fastening member. When the outer energy absorbing member and the inner energy absorbing member are disposed at the upper parts, it is possible to efficiently transmit a collision load to the floor cross member.

In the vehicle lower part structure according to the above aspect, the side member may be configured to include an inner panel and an outer panel, the inner panel having a flat plate shape, the inner panel being disposed so as to be opposed to the side frame, the outer panel having a hat shape in cross section, the outer panel being disposed on an outer side of the inner panel in the vehicle width direction, the outer panel being joined to the inner panel.

With the vehicle lower part structure, since the side member has a flat plate-shaped inner panel, the side frame can be brought into area contact with the side member, so the side frame and the side member can be firmly fastened.

As described above, with the vehicle lower part structure according to the aspect of the disclosure, it is possible to ensure space for mounting a battery with high versatility of a battery case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view that shows part of a vehicle lower part structure according to a first embodiment;

FIG. 2 is a relevant part enlarged sectional view taken along the line II-II in FIG. 1;

FIG. 3 is a side view that shows an example of a side module according to the first embodiment; and

FIG. 4 is a relevant part enlarged sectional view that shows a vehicle lower part structure according to a second embodiment and that corresponds to FIG. 2.

### DETAILED DESCRIPTION OF EMBODIMENTS

### First Embodiment

A vehicle lower part structure according to a first embodiment will be described with reference to the accompanying drawings.

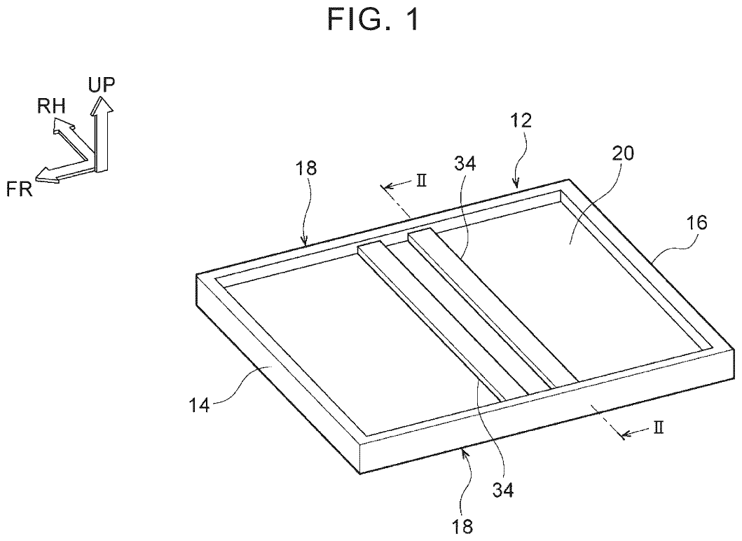

FIG. 1 is a perspective view that shows part of the vehicle lower part structure according to the first embodiment. The arrow FR, the arrow UP, and the arrow RH in the drawings respectively indicate a vehicle forward direction, a vehicle upward direction, and a direction to a vehicle right-hand side in a vehicle 10. In the following description, when front and rear, upper and lower, and right and left directions are used unless otherwise specified, these are assumed to indicate front and rear sides in a vehicle front and rear direction, upper and lower sides in a vehicle up and down direction, and right and left sides in a vehicle right and left direction (width direction).

As shown in FIG. 1, the vehicle lower part structure according to the present embodiment is configured to include a battery frame 12. The battery frame 12 is a substantially frame-shaped member surrounding the battery case 20 and is disposed below a vehicle cabin (not shown).

The battery frame 12 is configured to include a front frame 14, a rear frame 16, and a pair of right and left side frames 18. The front frame 14, the rear frame 16, and the side frames 18 may be formed of metal in one piece or separately. In the present embodiment, in an example, the front frame 14, the rear frame 16, and the side frames 18 each are formed by extrusion molding into a closed cross-section structure, and are joined to one another to form the battery frame 12.

The front frame 14 is located at a vehicle front part of the vehicle lower part structure and extends in the vehicle width direction along a vehicle front end of the battery case 20. A front module (not shown) that makes up a front part of the vehicle is joined to the front frame 14.

The rear frame 16 is located at a rear of the vehicle lower part structure and extends in the vehicle width direction along a vehicle rear end of the battery case 20. A rear module (not shown) that makes up a rear part of the vehicle is joined to the rear frame 16.

A right side end of the front frame 14 and a right side end of the rear frame 16 are coupled by the side frame 18 in the vehicle front and rear direction. A left side end of the front frame 14 and a left side end of the rear frame 16 are coupled by the side frame 18 in the vehicle front and rear direction.

The right and left side frames 18 respectively extend in the vehicle front and rear direction on outer sides of the battery case 20 in the vehicle width direction. Front ends of the side frames 18 are connected to the front frame 14. Rear ends of the side frames 18 are connected to the rear frame 16.

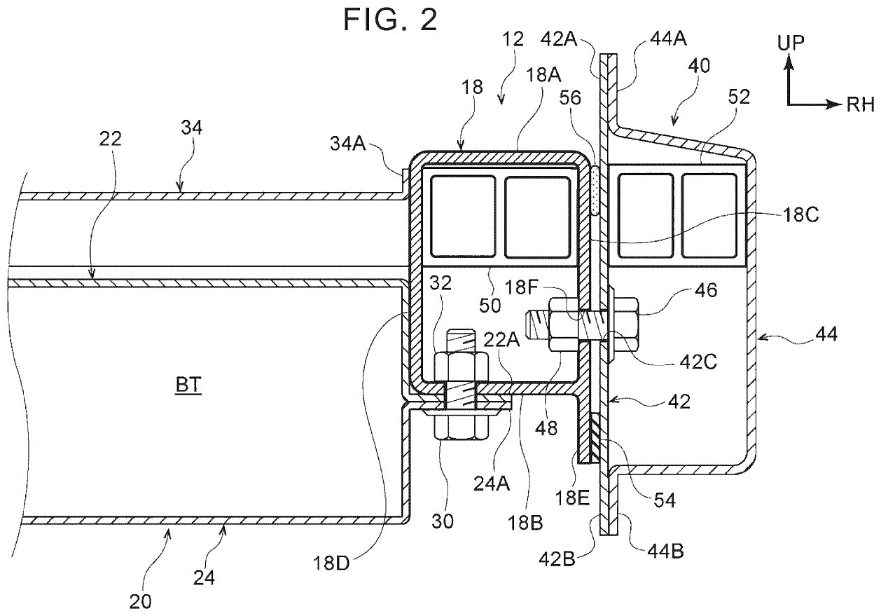

FIG. 2 is a relevant part enlarged sectional view taken along the line II-II in FIG. 1. As shown in FIG. 2, the side frame 18 includes an upper wall 18A, a lower wall 18B, a right wall 18C, and a left wall 18D. The side frame 18 has a closed cross-section structure such that the side frame 18 has a substantially rectangular outer shape in a sectional view when viewed in the vehicle front and rear direction.

The upper wall 18A is disposed at a location higher in level than the battery case 20 and extends in the vehicle width direction and the vehicle front and rear direction. The lower wall 18B is disposed at a location where the lower wall 18B overlaps the battery case 20 in a vehicle side view and extends in the vehicle width direction and the vehicle front and rear direction. In other words, the side frame 18 is provided at a location where the side frame 18 overlaps at least part of the battery case 20 in a vehicle side view.

The battery case 20 is configured to include an upper case 22 and a lower case 24. A battery BT is accommodated inside the battery case 20. The battery BT stores electric power to be supplied to a motor (not shown). The vehicle is configured to drive when the motor (not shown) operates on electric power supplied from the battery BT. The vehicle includes a power supply unit (not shown) and is configured such that electric power can be supplied from outside the vehicle to the battery BT via the power supply unit.

The upper case 22 is located at an upper part of the battery case 20. The upper case 22 has a substantially hat shape such that a cross section viewed in the vehicle front and rear direction is open toward a vehicle lower side. An upper right flange 22A extending along the lower wall 18B of the side frame 18 is provided at a vehicle right side end of the upper case 22.

The lower case 24 is located below the upper case 22. The lower case 24 has a substantially hat shape such that a cross section viewed in the vehicle front and rear direction is open toward a vehicle upper side. A lower right flange 24A put on the upper right flange 22A of the upper case 22 is provided at a vehicle right side end of the lower case 24. In a state where the upper right flange 22A and the lower right flange 24A are put one on the other, a bolt 30 extends through from the lower side and is screwed to a weld nut 32 provided on the lower wall 18B of the side frame 18.

A plurality of pairs of bolt 30 and weld nut 32 are provided at intervals in the vehicle front and rear direction. The battery case 20 is fastened to the side frame 18 by these pairs of bolt 30 and weld nut 32.

The right wall 18C of the side frame 18 couples right ends of the upper wall 18A and the lower wall 18B one above the other and is opposed to a side member 40 (described later) in the vehicle width direction. An elongated part 18E is elongated downward from a lower end of the right wall 18C.

The left wall 18D couples left ends of the upper wall 18A and the lower wall 18B one above the other. A floor cross member 34 is joined to the left wall 18D.

As shown in FIG. 1, in the present embodiment, in an example, two floor cross members 34 are provided and are disposed so as to be arranged in the vehicle front and rear direction. The floor cross member 34 is formed by pressing a sheet metal; however, the configuration is not limited thereto. The floor cross member 34 may be formed by extrusion molding, roll forming, casting, or the like.

Each of the floor cross members 34 has an upper surface, a front surface, and a rear surface and is formed in s substantially U-shape such that a cross section viewed in the vehicle width direction is open toward the vehicle lower side. As shown in FIG. 2, a gap is provided between the floor cross member 34 and the battery case 20. Furthermore, a bent part 34A bent upward along the left wall 18D of the side frame 18 is provided at an end of the upper surface of the floor cross member 34 in the vehicle width direction. The bent part 34A is joined by welding or the like in a state of being put on the left wall 18D of the side frame 18. In the present embodiment, the upper case 22 of the battery case 20 also serves as a floor panel that is a component of a floor of the vehicle cabin.

Bent parts (not shown) bent back and forth along the left wall 18D of the side frame 18 are provided at ends of the front surface and rear surface of the floor cross member 34 in the vehicle width direction. These bent parts are joined by welding or the like in a state of being put on the left wall 18D. The floor cross member 34 may be mechanically joined to the side frame 18 by a bolt, a rivet, or the like.

The side member 40 is disposed on an outer side of the side frame 18 in the vehicle width direction. The side member 40 includes a side inner panel 42 and a side outer panel 44 and has a closed cross-section structure.

The side inner panel 42 is a substantially plate-shaped member disposed so as to be opposed to the side frame 18 in the vehicle width direction and extends in the vehicle up and down direction and the vehicle front and rear direction. An upper end of the side inner panel 42 is located on a vehicle upper side of the upper wall 18A of the side frame 18. A lower end of the side inner panel 42 is located on a vehicle lower side of the lower wall 18B of the side frame 18.

The side outer panel 44 is disposed on an outer side of the side inner panel 42 in the vehicle width direction. The side outer panel 44 has a substantially hat shape such that a cross section is open toward an inner side in the vehicle width direction. An upper flange 44A bent upward along the side inner panel 42 is provided at an upper end of the side outer panel 44. The upper flange 44A is joined to the upper end 42A of the side inner panel 42 by spot welding or the like in a state where the upper flange 44A is put on the upper end 42A of the side inner panel 42.

A lower flange 44B bent downward along the side inner panel 42 is provided at a lower end of the side outer panel 44. The lower flange 44B is joined to the lower end 42B of the side inner panel 42 by spot welding or the like in a state where the lower flange 44B is put on the lower end 42B of the side inner panel 42.

Here, a closed cross section formed by the side inner panel 42 and the side outer panel 44 at least partially overlaps the side frame 18 in a vehicle side view. In the present embodiment, in an example, a closed cross section of the side member 40 overlaps the whole of the side frame 18 in a vehicle side view.

A bolt insertion hole 42C is formed at a lower part of the side inner panel 42 with respect to a central part in the vehicle up and down direction. A bolt insertion hole 18F is formed at a location where the bolt insertion hole 18F communicates with the bolt insertion hole 42C and is formed at a lower part of the right wall 18C of the side frame 18 with respect to a central part in the vehicle up and down direction. A bolt 46 serving as a fastening member is inserted through the bolt insertion hole 42C and the bolt insertion hole 18F from the outer side in the vehicle width direction. The bolt 46 is screwed to a weld nut 48 provided on the right wall 18C. In this way, the right wall 18C that is an outer-side wall of the side frame 18 in the vehicle width direction and the side inner panel 42 that is an inner-side wall of the side member 40 in the vehicle width direction are fastened by the bolt 46 and the weld nut 48 in the vehicle width direction. The side outer panel 44 has a work hole (not shown) and is configured so that the bolt 46 can be inserted through the work hole.

In the present embodiment, in an example, a seal member 54 and an adhesive 56 are provided between the side frame 18 and the side member 40. The seal member 54 is provided between the elongated part 18E and the side member 40 on a vehicle lower side of the bolt 46 and seals any gap between the elongated part 18E and the side member 40. The seal member 54 is not limited as long as the seal member 54 is made of a material capable of suppressing entry of water in between the side frame 18 and the side member 40.

The adhesive 56 is provided between the side inner panel 42 and the right wall 18C on a vehicle upper side of the bolt 46 and bonds the side inner panel 42 and the right wall 18C. Instead of the adhesive 56, a seal member similar to the seal member 54 may be provided. In the present embodiment, since the bolt 46 is located at a lower part of the right wall 18C with respect to a central part in an up and down direction, a good fastened state with the bolt 46 is maintained when the upper part of the right wall 18C is bonded to the side member 40 by the adhesive 56.

An outer energy absorbing member 52 is provided in the cross section of the side member 40. The outer energy absorbing member 52 has a sectional shape in which an internal space is partitioned in the vehicle width direction. The outer energy absorbing member 52 has a structure that crushes to absorb at least part of energy when a load is input in the vehicle width direction. The outer energy absorbing member 52 is located at an upper part in the cross section of the side member 40. Specifically, the outer energy absorbing member 52 is provided above the bolt 46 and is fixed to the side member 40. A method of fixing the outer energy absorbing member 52 is not limited. The outer energy absorbing member 52 may be fastened to the side member 40 mechanically, for example, by a bolt, a rivet, or the like or may be bonded to the side member 40 by an adhesive or the like. The outer energy absorbing member 52 may be fixed by sandwiching the outer energy absorbing member 52 by the side inner panel 42 and the side outer panel 44.

An inner energy absorbing member 50 is provided in the cross section of the side frame 18. The inner energy absorbing member 50 has a sectional shape in which an internal space is partitioned in the vehicle width direction. The inner energy absorbing member 50 has a structure that crushes to absorb at least part of energy when a load is input in the vehicle width direction. The inner energy absorbing member 50 is located at an upper part in the cross section of the side frame 18. Specifically, the inner energy absorbing member 50 is provided above the bolt 46. The inner energy absorbing member 50 is disposed at a location where at least part of the inner energy absorbing member 50 overlaps the outer energy absorbing member 52 in a vehicle side view and fixed to the side frame 18. A method of fixing the inner energy absorbing member 50 is not limited. The inner energy absorbing member 50 may be fastened to the side frame 18 mechanically, for example, by a bolt, a rivet, or the like or may be bonded to the side frame 18 by an adhesive or the like.

Here, in the present embodiment, the outer energy absorbing member 52, the inner energy absorbing member 50, and the floor cross members 34 are disposed so as to overlap with one another in a vehicle side view. In the present embodiment, in an example, the outer energy absorbing member 52 and the inner energy absorbing member 50 each are configured such that the internal space is partitioned into two in the vehicle width direction by a partition wall extending in the vehicle up and down direction; however, the configuration is not limited thereto. The outer energy absorbing member 52 and the inner energy absorbing member 50 each may be configured such that the internal space is partitioned into three or more in the vehicle width direction by providing two or more partition walls. As long as a structure is capable of crushing to absorb energy when a load is input, another structure may be adopted. For example, a structure with no partition wall or a structure with an inclined partition wall may be adopted.

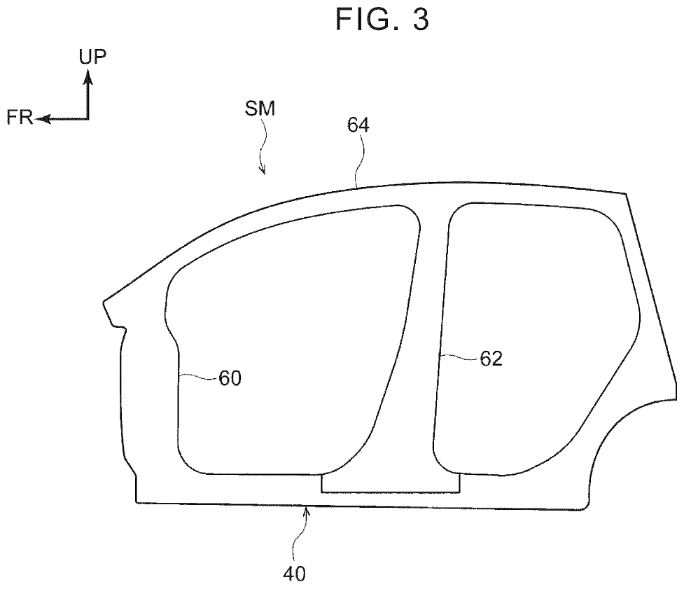

Next, an example of a manufacturing method for a vehicle that has the vehicle lower part structure according to the present embodiment will be described. FIG. 3 is a side view that shows an example of a side module SM according to the present embodiment. In the present embodiment, in an example, the side module SM is formed in advance.

The side module SM is configured to include the side member 40, a front pillar 60, a center pillar 62, and a roof side rail 64. The front pillar 60 is a framework member extending in the vehicle up and down direction. A lower end of the front pillar 60 is connected to a front end of the side member 40. The front pillar 60 and the side member 40 may be joined by welding or the like or may be fastened mechanically by a bolt, a rivet, or the like.

The center pillar 62 is provided on a vehicle rear side of the front pillar 60. The center pillar 62 is a framework member extending in the vehicle up and down direction. A lower end of the center pillar 62 is connected to a central part of the side member 40 in the vehicle front and rear direction. The center pillar 62 and the side member 40 may be joined by welding or the like or may be fastened mechanically by a bolt, a rivet, or the like.

An upper end of the front pillar 60 and an upper end of the center pillar 62 are connected to the roof side rail 64. The roof side rail 64 is a framework member extending in the vehicle front and rear direction. A roof panel (not shown) is fixed to the roof side rail 64.

On the other hand, as shown in FIG. 1, in a state where the floor cross members 34 are joined to the battery frame 12, the battery case 20 is fastened to the side frames 18 of the battery frame 12.

As shown in FIG. 2, the side member 40 that is a component of the side module SM is fastened by the bolt 46 and the weld nut 48 to the side frame 18 to which the battery case 20 is fastened.

### Operation

Next, the operation of the vehicle lower part structure according to the present embodiment will be described.

In the vehicle lower part structure according to the present embodiment, as shown in FIG. 1, the side frames 18 extend in the vehicle front and rear direction on the outer sides of the battery case 20 in the vehicle width direction. As shown in FIG. 2, the side frame 18 has a closed cross-section structure and is provided at a location where the side frame 18 overlaps at least part of the battery BT in a vehicle side view. Thus, a collision load input from the side of the vehicle in the event of a side collision of the vehicle can be received by the side frame 18, so the battery BT is protected.

The side member 40 is disposed on the outer side of the side frame 18 in the vehicle width direction. The side member 40 is fastened to the side frame 18 by the bolt 46 that is a fastening member. In this way, with the structure that the side frame 18 and the side member 40 are fastened by the bolt 46, the side frame 18 is proximate to the side member 40, and space for mounting the battery BT in the vehicle width direction can be ensured.

Furthermore, the side member 40 has a closed cross-section structure and is provided at a location where the side member 40 overlaps at least part of the side frame 18 in a vehicle side view. In this way, the side frame 18 and the side member 40 each having a closed cross-section structure can function as a rocker that is a vehicle framework member. Then, the vehicle lower part structure is applicable to vehicles having different vehicle ranks just by changing the side member 40, so the battery BT and the side frame 18 do not need to be changed, and the structure has high versatility. As a result, the vehicle lower part structure according to the present embodiment ensures space for mounting the battery BT with high versatility.

Particularly, in the present embodiment, the side frame 18 and the side member 40 are fastened by the bolt 46 in the vehicle width direction. Thus, in the event of a side collision, a load is input along the axial direction of the bolt 46, so a good fastened state can be maintained as compared to a case where a load is input to the bolt in a shearing direction in the event of a side collision like a structure fastened one above the other by a bolt.

Furthermore, in the present embodiment, when the outer energy absorbing member 52 is provided in the cross section of the side member 40, at least part of a collision load input from the side of the vehicle in the event of a side collision of the vehicle can be absorbed by the outer energy absorbing member 52.

As in the case of the side member 40, when the inner energy absorbing member 50 is provided in the cross section of the side frame 18, at least part of a collision load input from the side of the vehicle in the event of a side collision of the vehicle can be absorbed by the inner energy absorbing member 50. At least part of the inner energy absorbing member 50 overlaps the outer energy absorbing member 52 in a vehicle side view. For this reason, a collision load can be effectively absorbed by both the outer energy absorbing member 52 and the inner energy absorbing member 50, and a load input to the battery BT can be reduced.

In the present embodiment, the floor cross member 34 extending in the vehicle width direction is connected to the side frame 18. Furthermore, the inner energy absorbing member 50 is provided at a location where at least part of the inner energy absorbing member 50 overlaps the floor cross member 34 in a vehicle side view. For this reason, a collision load input from the side of the vehicle in the event of a side collision can be absorbed by the inner energy absorbing member 50 and can also be transmitted to an anti-collision side via the side frame 18 and the floor cross member 34. As a result, a load input to the battery BT can be effectively reduced.

Furthermore, in the present embodiment, as shown in FIG. 3, the front pillar 60 and the center pillar 62 are connected to the side member 40, and the side module SM including the side member 40, the front pillar 60, and the center pillar 62 is formed. Thus, when the side member 40, the front pillar 60, and the center pillar 62 are modularized in advance, the framework of the vehicle can be formed just by fastening the battery BT and the side frame 18 to the modularized side module SM.

Furthermore, in the present embodiment, as shown in FIG. 2, the outer energy absorbing member 52 and the inner energy absorbing member 50 are respectively disposed at the upper parts in the cross sections, and the bolt 46 is inserted at the lower parts in the cross sections, so it is possible to reduce interference of the outer energy absorbing member 52 and the inner energy absorbing member 50 at the time of fastening the side frame 18 and the side member 40 to each other by the bolt 46. When the outer energy absorbing member 52 and the inner energy absorbing member 50 are disposed at the upper parts, it is possible to efficiently transmit a collision load to the floor cross member 34.

In the present embodiment, since the side member 40 includes the plate-shaped side inner panel 42, the side frame 18 can be brought into area contact with the side member 40, and the side frame 18 can be firmly fastened to the side member 40. In the present embodiment, the seal member 54 and the adhesive 56 are provided between the side frame 18 and the side member 40; however, both the seal member 54 and the adhesive 56 are thin, so the side frame 18 and the side member 40 are almost in area contact with each other.

### Second Embodiment

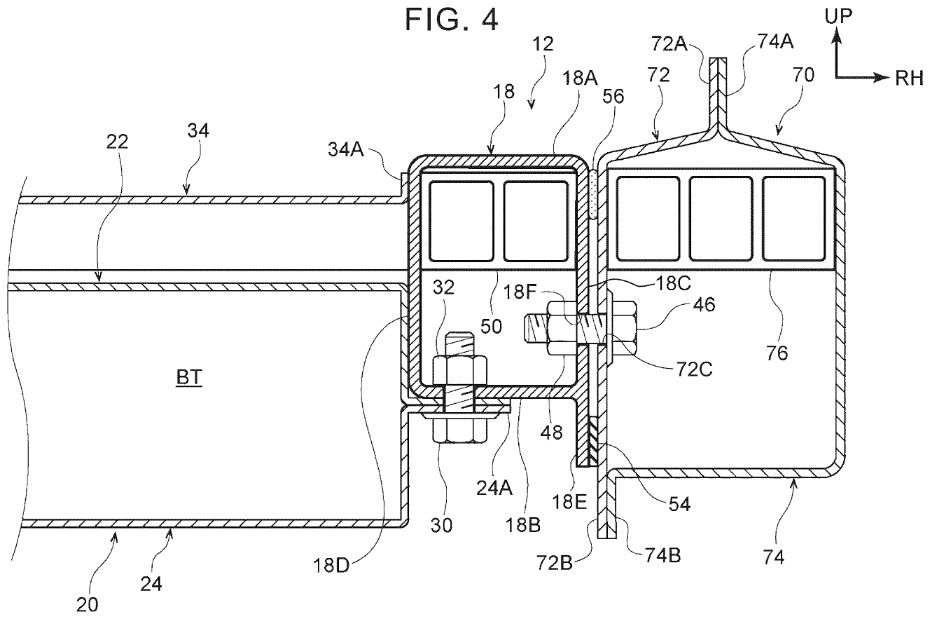

Next, a vehicle lower part structure according to a second embodiment will be described with reference to FIG. 4. Like reference signs denote similar components to those of the first embodiment, and the description will not be repeated as needed.

FIG. 4 is a relevant part enlarged sectional view of a vehicle lower part structure according to a second embodiment. As shown in FIG. 4, the vehicle lower part structure according to the present embodiment has a similar configuration to that of the first embodiment except a side member 70.

The side member 70 according to the present embodiment is disposed on an outer side of the side frame 18 in the vehicle width direction. The side member 70 has a closed cross-section structure and includes a side inner panel 72 and a side outer panel 74.

The side inner panel 72 is disposed so as to be opposed to the side frame 18 in the vehicle width direction and has a substantially crank shape in a cross section viewed in the vehicle front and rear direction. Specifically, a part of the side inner panel 72, opposed to the side frame 18, extends in the vehicle up and down direction, and a lower end 72B of the side inner panel 72 is located on a vehicle lower side of the lower wall 18B of the side frame 18.

An upper part of the side inner panel 72 extends obliquely toward the outer side in the vehicle width direction and a vehicle upper side and further is bent toward the vehicle upper side to provide an upper flange 72A.

The side outer panel 74 is disposed on an outer side of the side inner panel 72 in the vehicle width direction and has a substantially hat shape such that a cross section is open toward an inner side in the vehicle width direction. An upper flange 74A bent upward along the upper flange 72A of the side inner panel 72 is provided at an upper end of the side outer panel 74. In a state where the upper flange 72A of the side inner panel 72 and the upper flange 74A of the side outer panel 74 are put on each other, the upper flange 72A and the upper flange 74A are joined by spot welding or the like.

A lower flange 74B bent downward along the side inner panel 72 is provided at a lower end of the side outer panel 74. The lower flange 74B is joined to the lower end 72B of the side inner panel 72 by spot welding or the like in a state where the lower flange 74B is put on the lower end 72B of the side inner panel 72.

Here, a closed cross section formed by the side inner panel 72 and the side outer panel 74 at least partially overlaps the side frame 18 in a vehicle side view. In the present embodiment, in an example, a closed cross section of the side member 70 overlaps the whole of the side frame 18 in a vehicle side view.

A bolt insertion hole 72C is formed at a central part of the side inner panel 72 in the vehicle up and down direction. A bolt insertion hole 18F is formed at a location where the bolt insertion hole 18F communicates with the bolt insertion hole 72C and is formed at a lower part of the right wall 18C of the side frame 18 with respect to a central part in the vehicle up and down direction. A bolt 46 serving as a fastening member is inserted through the bolt insertion hole 72C and the bolt insertion hole 18F from the outer side in the vehicle width direction. The bolt 46 is screwed to a weld nut 48 provided on the right wall 18C. In this way, the right wall 18C that is an outer-side wall of the side frame 18 in the vehicle width direction and the side inner panel 72 that is an inner-side wall of the side member 70 in the vehicle width direction are fastened by the bolt 46 and the weld nut 48 in the vehicle width direction. The side outer panel 74 has a work hole (not shown) and is configured so that the bolt 46 can be inserted through the work hole.

As in the case of the first embodiment, a seal member 54 and an adhesive 56 are provided between the side frame 18 and the side member 70. The seal member 54 is provided between the elongated part 18E and the side member 70 on a vehicle lower side of the bolt 46 and seals any gap between the elongated part 18E and the side member 70. The adhesive 56 is provided between the side inner panel 72 and the right wall 18C on a vehicle upper side of the bolt 46 and bonds the side inner panel 72 and the right wall 18C.

An outer energy absorbing member 76 is provided in the cross section of the side member 70. The outer energy absorbing member 76 has a sectional shape in which an internal space is partitioned into three in the vehicle width direction. The outer energy absorbing member 76 has a structure that crushes to absorb at least part of energy when a load is input in the vehicle width direction. The outer energy absorbing member 76 is located at an upper part in the cross section of the side member 70. Specifically, the outer energy absorbing member 76 is provided above the bolt 46 and is fixed to the side member 70.

### Operation

Next, the operation of the vehicle lower part structure according to the present embodiment will be described.

The present embodiment differs from the first embodiment in the shape of the side member 70, and the size of the side member 70 in the vehicle width direction is greater than that of the side member 40 according to the first embodiment. For this reason, by applying the side member 70 according to the present embodiment, the shapes of the battery case 20 and the side frame 18 do not need to be changed even for high-rank vehicles. The remaining operation is similar to that of the first embodiment.

The vehicle lower part structure according to the aspect of the disclosure has been described; however, the disclosure may be, of course, implemented in various modes without departing from the scope of the disclosure. For example, in the above-described embodiment, the inner energy absorbing member 50 is provided inside the side frame 18, and the outer energy absorbing member 52 is provided inside the side member 40; however, the configuration is not limited thereto. The vehicle lower part structure may be configured not to include the inner energy absorbing member 50 or the outer energy absorbing member 52.

In the above-described embodiments, a gap is formed between the floor cross member 34 and the battery case 20; however, the configuration is not limited thereto. A configuration that the floor cross member 34 is secured to the battery case 20 may be adopted.

Furthermore, in the present embodiments, the battery BT is accommodated in the battery case 20; however, the configuration is not limited thereto. For example, a structure in which a battery is directly accommodated between the right and left side frames 18 may be adopted. In this case, for example, a structure in which a battery is disposed on a support cover that supports the battery from the lower side and a cover that also serves as a floor panel is secured from the upper side of the side frame 18 can be adopted.

The following addenda will be described in relation to the above-described embodiments.

### Addendum 1

A vehicle lower part structure includes: a side frame having a closed cross-section structure, the side frame extending in a vehicle front and rear direction on an outer side of a battery in a vehicle width direction, the side frame being provided at a location where the side frame overlaps at least part of the battery in a vehicle side view; and a side member having a closed cross-section structure, the side member being disposed on an outer side of the side frame in the vehicle width direction, the side member being provided at a location where the side member overlaps at least part of the side frame in a vehicle side view, the side member being fastened to the side frame by a fastening member.

### Addendum 2

In the vehicle lower part structure according to Addendum 1, an outer energy absorbing member is provided in a cross section of the side member.

### Addendum 3

In the vehicle lower part structure according to Addendum 2, an inner energy absorbing member is provided in a cross section of the side frame at a location where at least part of the inner energy absorbing member overlaps the outer energy absorbing member in a vehicle side view.

### Addendum 4

In the vehicle lower part structure according to Addendum 3, a floor cross member extending in the vehicle width direction is connected to the side frame, and the inner energy absorbing member is provided at a location where at least part of the inner energy absorbing member overlaps the floor cross member in a vehicle side view.

Addendum 5 In the vehicle lower part structure according to any one of Addenda 1 to 4, a front pillar extending in a vehicle up and down direction is connected to a vehicle front side of the side member, and a center pillar extending in the vehicle up and down direction is connected to the side member on a vehicle rear side of the front pillar.

### Addendum 6

In the vehicle lower part structure according to any one of Addenda 1 to 5, a wall of the side frame at an outer side in the vehicle width direction and a wall of the side member at an inner side in the vehicle width direction are fastened by the fastening member in the vehicle width direction.

### Addendum 7

In the vehicle lower part structure according to Addendum 3, the outer energy absorbing member is disposed at an upper part in the cross section of the side member, the inner energy absorbing member is disposed at an upper part in the cross section of the side frame, and the fastening member is disposed below the outer energy absorbing member and the inner energy absorbing member.

### Addendum 8

In the vehicle lower part structure according to any one of Addenda 1 to 7, the side member is configured to include an inner panel and an outer panel, the inner panel having a flat plate shape, the inner panel being disposed so as to be opposed to the side frame, the outer panel having a hat shape in cross section, the outer panel being disposed on an outer side of the inner panel in the vehicle width direction, the outer panel being joined to the inner panel.

What is claimed is:

1. A vehicle lower part structure comprising:
a side frame having a closed cross-section structure, the side frame extending in a vehicle front and rear direction on an outer side of a battery in a vehicle width direction, the side frame being provided at a location where the side frame overlaps at least part of the battery in a vehicle side view; and
a side member having a closed cross-section structure, the side member being disposed on an outer side of the side frame in the vehicle width direction, the side member being provided at a location where the side member overlaps at least part of the side frame in a vehicle side view, the side member being fastened to the side frame by a fastening member.

2. The vehicle lower part structure according to claim 1, wherein an outer energy absorbing member is provided in a cross section of the side member.

3. The vehicle lower part structure according to claim 2, wherein an inner energy absorbing member is provided in a cross section of the side frame at a location where at least part of the inner energy absorbing member overlaps the outer energy absorbing member in a vehicle side view.

4. The vehicle lower part structure according to claim 3, wherein:
a floor cross member extending in the vehicle width direction is connected to the side frame; and
the inner energy absorbing member is provided at a location where at least part of the inner energy absorbing member overlaps the floor cross member in a vehicle side view.

5. The vehicle lower part structure according to claim 1, wherein:
a front pillar extending in a vehicle up and down direction is connected to a vehicle front side of the side member; and
a center pillar extending in the vehicle up and down direction is connected to the side member on a vehicle rear side of the front pillar.

6. The vehicle lower part structure according to claim 1, wherein a wall of the side frame at an outer side in the vehicle width direction and a wall of the side member at an inner side in the vehicle width direction are fastened by the fastening member in the vehicle width direction.

7. The vehicle lower part structure according to claim 3, wherein:
the outer energy absorbing member is disposed at an upper part in the cross section of the side member;
the inner energy absorbing member is disposed at an upper part in the cross section of the side frame; and
the fastening member is disposed below the outer energy absorbing member and the inner energy absorbing member.

8. The vehicle lower part structure according to claim 1, wherein the side member is configured to include an inner panel and an outer panel, the inner panel having a flat plate shape, the inner panel being disposed so as to be opposed to the side frame, the outer panel having a hat shape in cross section, the outer panel being disposed on an outer side of the inner panel in the vehicle width direction, the outer panel being joined to the inner panel.
